(19) United States
(12) Patent Application Publication
(10) Pub. No.: US 2007/0286662 A1
(43) Pub. Date: Dec. 13, 2007

(54) Convertible computer keyboard

(76) Inventor: Eric J. King, Hammonton, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 11/448,361

(22) Filed: Jun. 7, 2006

(51) Int. Cl. B41J 5/00

(52) U.S. Cl. 400/489

(57) ABSTRACT

A convertible computer keyboard has two sections, a QWERTY typing and a key/numpad section. The sections are configured to be used as a single unit or independently of one another. Connection of the sections is made possible by the use of a channeled track or equivalent connection system, which allows a rigid attachment of the key/numpad section on either side of the QWERTY section. The sections of the keyboard can also be connected as a unit or used separately, with wireless connectors which transmit electronic input signals to the computer. As a result of its convertible nature, the keyboard has the flexibility to be configured in a number of ways, thus ergonomically enhancing keyboard use and versatility, especially for video gamers.

### BACKGROUND OF THE INVENTION

Traditional keyboards used at computer and video game terminals generally include a unitary board onto which alphanumeric keys are attached. Such common keyboards are approximately twenty inches long and have the QWERTY typing section on the lefthand side, which accounts for about two thirds of the keyboard, and the arrow keys/number pad section on the right side, accounting for about the remaining third. The two sections are attached, usually separated by a narrow connecting piece. However, because such common keyboards are limited to this configuration, they present a number of significant disadvantages.

For example, the standard configuration does not permit the operator any flexibility in positioning the keyboard. Often times the operator must contort his or her wrists, arms, and or shoulders to accommodate the keyboard. This results, at the very least, in operator discomfort and, sometimes, in significant injury. Also, due to size limitations of desk surfaces, operators are often forced to sit in awkward positions to use their keyboards.

The video gaming community is especially hampered by the standard keyboard design. Many video “gamers” find it difficult to work such standard keyboards, in that they are unable to position them for optimum use. In addition, a majority of gamers use the arrow keys and their surrounding function keys to move around and “play” their games. The gamers who do not prefer the arrow keys use the W, A, S, and D keys in the same manner as the arrow keys. However, regardless of the preference, the standard keyboard configuration fails to allow the gamer the flexibility to alter the position of the operational keys. In addition, due to size limitations of desks, gamers using standard keyboards also often must sit in awkward positions in order to accommodate keyboard placement. Over an extended amount of play time, gamers can get uncomfortable, adversely effecting play. The static spacing and location of the keys hampers playing ability as well. These restrictions in ergonomic and gaming functionality severely compromise game play. Having the ability to set up a keyboard, for optimum use, based on the preference of the gamer, would constitute a significant improvement over existing keyboard configurations.

### SUMMARY OF THE INVENTION

The present invention addresses the limitations and disadvantages of existing computer keyboard configurations and solves the problems which result. The convertible computer keyboard of the present invention consists of two sections, a QWERTY typing and a key/numpad section. The sections are configured to be used as a single unit or independently of one another. Connection of the sections is made possible by the use of a channeled track or equivalent connection system, which allows a rigid attachment of the key/numpad section on either side of the QWERTY section.

As a result of its convertible nature, the keyboard of the present invention has the flexibility to be configured in a number of ways, thus ergonomically enhancing keyboard use and versatility, especially for video gamers.

The most common combination would be the connection of the arrow keys/numpad section to the right side of the QWERTY section. This is the traditional model which provides the standard keyboard layout and is always important since gamers and other household members require the standard keyboard for many home computer operations. However, since the channeled track system of the present invention is provided on both sides of the QWERTY section and the arrow key/numpad section, it is possible to connect the arrow keys/numpad section to the left side of the QWERTY section. To accomplish this, the arrow keys/numpad section need only be disconnected from the standard keyboard layout and then reconnected to the left side of the QWERTY section for a rigid connection. This configuration serves to enhance the comfort level of the gamers, as it is more convenient to have the arrow keys/numpad section on the lefthand side, further away from the mouse, thus now centering the typing area between the gamer's hands.

Another configuration of the keyboard of the present invention takes advantage of the wiring system that will be used to transfer information from keyboard to PC. This configuration will enable the garner to completely detach the arrow keys/numpad section from the QWERTY section. The arrow key/numpad section can act independently when plugged by hard wire into the PC. While the arrow key/numpad section is independent of the QWERTY section, the latter section can still be used, if need be, with the connection of an additional wire. This configuration will again serve as a comfortable way to play a computer game. In addition, by having the capability to detach and store either the QWERTY section or the arrow key/numpad section, the gainer frees up valuable desktop space.

All configurations of the keyboard of the present invention can also function wirelessly, since the back of the keyboard has a port for the connection of a wire. A wireless adaptor/battery pack combination can be substituted for the hard wire connection. Such a wireless combination is manufactured as one unit and can simply be swapped in and out with the wired cord.

Novel features which are considered as characteristic of the invention are set forth in particular in the dependent claims. The invention, itself, however, both as to its design, construction and use, together with the additional features and advantages thereof, are best understood upon review of the following detailed description with reference to the accompanying drawings.

### BRIEF DESCRIPTION OF THE DRAWINGS

FIG. 1 is a top view of the convertible keyboard of the present invention attached in one of its use configurations.

FIG. 2 is a top view of the convertible keyboard of the present invention showing a second use configuration.

FIG. 3 is a top view of the convertible keyboard of the present invention showing a wireless use configuration.

FIG. 4 is a top view of the convertible keyboard of the present invention showing a second wireless use configuration.

FIG. 5 shows a partial, isometric rear view of the connectible keyboard of the present invention.

FIG. 6 shows the front view of a wired connector to be used with the convertible keyboard of the present invention.

FIG. 7 shows the rear view of the wired connector shown in FIG. 7.

FIG. 8 shows a battery powered wireless connector to be used with the convertible keyboard of the present invention.

FIG. 9 shows one manner of rigid connection of the arrow key/numpad section to the left side of the QWERTY section of the convertible keyboard of the present invention.

FIG. 10 shows one manner of rigid connection of the arrow key/numpad section to the right side of the QWERTY section of the convertible keyboard of the present invention.

FIG. 11 is a view of the rigid connection taken from FIG. 10.

### DETAILED DESCRIPTION OF THE INVENTION

Keyboard 1 of the present invention comprises keyboard section 2 and keyboard section 4. Keyboard section 2 is a standard QWERTY typing section and normally would comprise approximately two thirds of keyboard 1 when connected to keyboard section 4. Keyboard section 4 is an arrow key/numpad section, used not only for traditional keyboard activities, but it represents a video gaming configuration as well, so it also operates computer-run video games, often in combination with keyboard section 2.

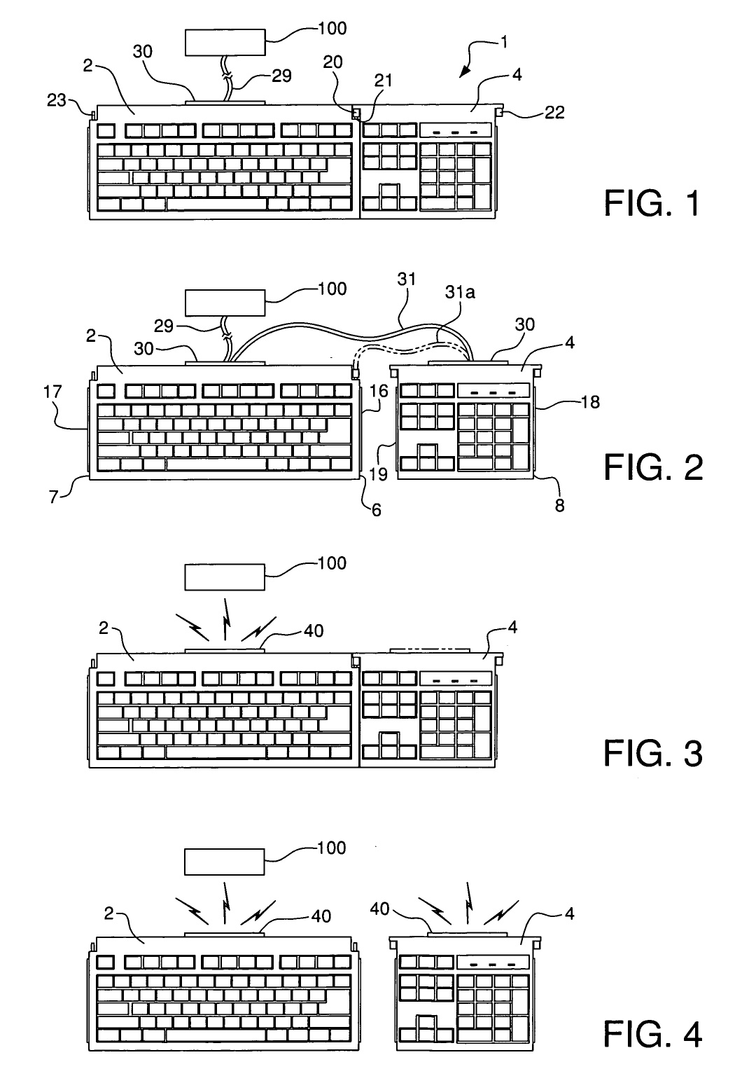

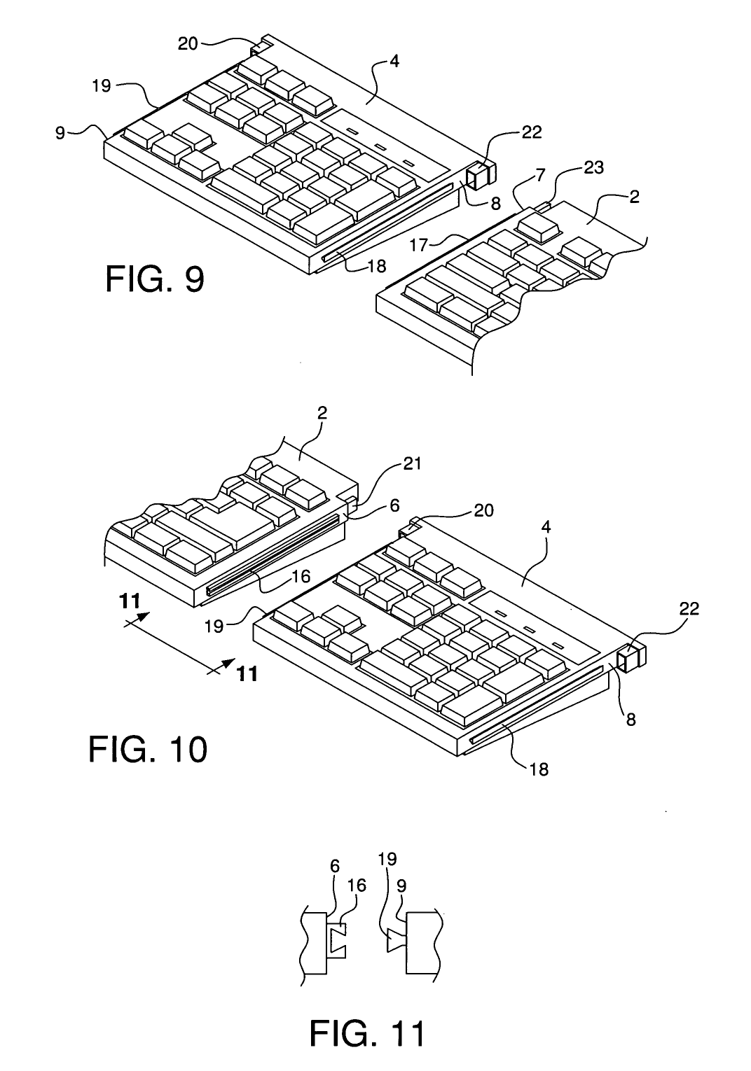

Keyboard section 2 has lateral edge surfaces 6 and 7 and keyboard section 4 has lateral edge surfaces 8 and 9. Lateral edge surfaces 6 and 7 have channeled tracks or grooves 16 and 17 configured to slideably accept tongue members 18 and 19 outstanding from surfaces 8 and 9 of keyboard section 4. By sliding tongue member 19 into channeled track 16, keyboard sections 2 and 4 are rigidly connected to be operated as a single integral unit, with keyboard section 4 connected on the right side of keyboard 2, as shown in FIG. 1, in the manner of connection depicted in FIGS. 9 and 10.

Tongue member 19 of keyboard section 4 can be slid out of channeled track 16 of keyboard section 2, disengaging the two keyboard sections. By then sliding tongue member 18 into channeled track 17, keyboard sections 2 and 4 can again be rigidly connected to be operated as a single, integral unit, with keyboard section 4 now connected on the left side of keyboard 2, as shown in the manner of connection depicted in FIG. 8.

FIGS. 9 and 10 specifically show one example of a channeled track/tongue member connection. However, the configuration of the channeled track and tongue members used for this slideable connection should not be considered so restricted. It is contemplated that various and equivalent configurations and shapes of channeled track and tongue members can be used and the manner of removeable connection between keyboard sections of the invention is not to be considered limited to that which is disclosed herein.

In the configurations shown, keyboard section 4 comprises two USB ports 20 and 22, which are designed to mate with USB port snap connections 21 and 23 of keyboard section 2.

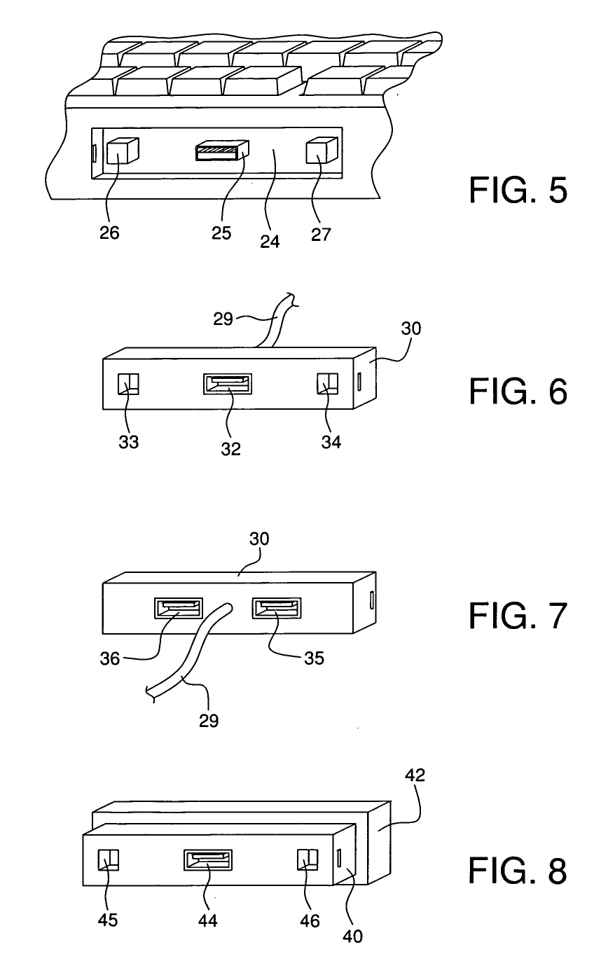

Connector section 24 is recessed into the rear of either or both keyboard sections 2 and 4. This permits either section of the convertible keyboard 1 to interconnect with computer 100 directly, via wire 29. Connector section 24 comprises USB outport 25 for additional component connection, as seen in FIG. 5. Connector section 24 also has guide tabs 26 and 27 which are configured to be inserted into auxiliary components, such as hardwire connector 30 or wireless connector 40.

Hardwire connector 30, shown in FIGS. 6 and 7, comprises USB receiving port 32 and guide tab receptacles 33 and 34. Wire 29 extends from connector 30, to computer 100. Connector 30 is configured to be received and attached to recessed connector section 24, located at the rear of either or both keyboard sections 2 and 4. USB ports 35 and 36 are located on the back side of connector 30.

FIG. 1 shows wire connector 30 attached to keyboard section 2, with wire 29 extending to computer 100, to operate keyboard 1 with rigidly connected sections 2 and 4, USB port 20 of section 4 being connected to USB port snap connection 21. FIG. 2 shows sections 2 and 4 physically separated, both sections having a connector 30 attached to their respective rear surfaces. In this configuration, one of the USB ports in connector 30, attached to keyboard section 2, receives wire 31 from one of the USB ports in connector 30, attached to the rear surface of keyboard section 4. This serves to allow hardwire operation of computer 100 by sections 2 and 4, while permitting the sections to be placed at different locations based on the user's preference. Alternatively, the USB connection between sections 2 and 4 can be made by wire 31a connection attached between one of the USB ports in connector 30 attached to section 4 and USB snap connection 21 on section 2.

It is also contemplated that wireless connector 40, which is battery 42 operated, can be used in conjunction with computer 100 via keyboard 1 and both its sections 2 and 4. Wireless connector 40, shown in FIG. 8, has USB port 44 and guide tabs 45 and 46 which are configured to be inserted into the openings in the rear of keyboard section 2. FIG. 3 shows keyboard 1 with keyboard sections 2 and 4 rigidly attached, in a wireless mode. Wireless connector 40 can be used on either section 2 or 4. FIG. 4 shows the physical separation of keyboard sections 2 and 4 and the use of wireless connectors 40 on both sections. Since both sections are fitted with battery operated wireless connectors 40, they can each independently transmit electronic input signals to computer 100. This arrangement provides the user with increased versatility and even more options in operating the keyboard.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A video game friendly keyboard for use in operating a computer and computer video games, said keyboard comprising:
a first keyboard section having lateral edge surfaces, said keyboard section also having a QWERTY configuration;
a second keyboard section separate and independent from the first keyboard section, said second keyboard section having a video gaming configuration; and
connection means to rigidly attach the first keyboard section to the second keyboard section at either lateral edge surface of the first keyboard section, whereby when the first keyboard section and the second keyboard section are attached by the connection means at either lateral edge surface of the first keyboard section, the keyboard is a single, integral operable unit and when the first keyboard section and the second keyboard section are separated and independent, each keyboard section can be operated individual or in tandem when the sections are in different locations.

2. The keyboard as in claim 1 further comprising means to transmit computer and video game input signals from the first keyboard section and from the second keyboard section, said means being operable to transmit said signals both when the sections are attached by the connection means and when they are separated from each other and in different locations.

3. The keyboard as in claim 1 wherein the connection means comprises a tongue and groove connector system.

4. The keyboard as in claim 2 wherein when the sections are separated, the means to transmit comprises a hard line connection between the first and second keyboard sections and between the sections and the computer.

5. The keyboard as in claim 2 wherein when the keyboard sections are rigidly attached, the means to transmit comprises a hard line connection between the keyboard sections and between the sections and the computer.

6. The keyboard as in claim 2 wherein the means to transmit comprises a wireless adapter means to transmit computer and video gaming input signals.

7. The keyboard as in claim 6 wherein when the first keyboard section and second keyboard sections are rigidly attached the wireless adapter means is located on the first keyboard section.

8. The keyboard as in claim 6 wherein when the sections are separated, the wireless adapter means is located on both the first keyboard section and the second keyboard section.

9. The keyboard as in claim 1 wherein the first keyboard section further comprises connection ports for the transmission of computer and video gaming input signals from the first and second keyboard sections to the computer.

10. The keyboard as in claim 1 wherein the first keyboard section further comprises input ports for receiving wireless adapter means to transmit computer and video gaming signals from the first and second keyboard sections when the sections are rigidly attached.

11. The keyboard as in claim 1 wherein the first keyboard section and the second keyboard section each have wireless adapter means to transmit computer and video gaming signals to the computer when the sections are separated and positioned in different locations.

12. A videogame friendly keyboard for use in operating a computer and computer videogames, said keyboard comprising:
a first keyboard section having lateral edge surfaces, said keyboard section also having a QWERTY configuration;
a second keyboard section separate and independent from the first keyboard section, said second keyboard section having a video gaming configuration;
first connection means to rigidly attach the first keyboard section to the second keyboard section at either lateral edge surface of the first keyboard section, whereby when the first keyboard section and the second keyboard section are attached by the connection means at either lateral edge surface of the first keyboard section, the keyboard is a single, integral, operable unit; and
means to transmit computer and video gaming input signals from the first keyboard section and from the second keyboard section, said means being operable to transmit said signals both when the sections are separated from each other and when they are attached by the connection means.

13. The keyboard as in claim 12 wherein the connection means comprises a tongue and groove connector system.

14. The keyboard as in claim 12 wherein when the sections are separated, the means to transmit comprises a hard line connection between the first and second keyboard sections and between the sections and the computer.

15. The keyboard as in claim 12 wherein when the keyboard sections are rigidly attached, the means to transmit comprises a hard line connection between the keyboard sections and between the sections and the computer.

16. The keyboard as in claim 12 wherein the means to transmit comprises a wireless adapter means to transmit computer and video gaming input signals.

17. The keyboard as in claim 16 wherein when the first keyboard section and second keyboard sections are rigidly attached the wireless adapter means is located on the first keyboard section.

18. The keyboard as in claim 16 wherein when the sections are separated, the wireless adapter means is located on both the first keyboard section and the second keyboard section.

19. The keyboard as in claim 12 wherein the first keyboard section further comprises connection ports for the transmission of computer and video gaming input signals from the first and second keyboard sections to the computer.

20. The keyboard as in claim 12 wherein the first keyboard section further comprises input ports for receiving wireless adapter means to transmit computer and video gaming signals from the first and second keyboard sections when the sections are rigidly attached.

21. The keyboard as in claim 12 wherein the first keyboard section and the second keyboard section each have wireless adapter means to transmit computer and video gaming signals to the computer when the sections are separated and positioned in different locations.
